(19) United States
(12) Patent Application Publication
(10) Pub. No.: US 2018/0094144 A1
(43) Pub. Date: Apr. 5, 2018

(54) OUTER COATING FOR SHIP HULL

(71) Applicant: Christian BUMM, Buergstadt (DE)

(72) Inventor: Christian BUMM, Buergstadt (DE)

(21) Appl. No.: 15/572,088

(22) PCT Filed: May 25, 2016
(86) PCT No.: PCT/EP2016/000865

§ 371 Date: Nov. 6, 2017

(30) Foreign Application Priority Data
May 27, 2015 (DE) 10 2015 006 546.7

(51) Int. Cl. C09D 5/16; C09J 133/08; C09J 163/00; C09J 7/10; B32B 27/12; B32B 27/32; B63B 59/04

(52) U.S. Cl. CPC C09D 5/1693; C09J 133/08; C09J 163/00; C09J 7/10; B32B 2605/16; B32B 27/32; B63B 59/04; C09J 2463/00; C09J 2433/00; B32B 27/12

(57) ABSTRACT

The invention relates to an outer coating of a ship's hull in the underwater area, wherein the coating comprises a bottom layer on the hull exterior, said layer being made of an adhesive or an ethylene-propylene-diene rubber and being particularly designed as a film, and a superimposed top layer made of an ultra high-molecular weight polyethylene.

The invention relates to an external ship- or boat-hull coating in the submarine sector.

Film coatings intended to reduce fouling in water are known for boat hulls. One first method adhesive-bonds transparent PVC films to the hull in order to reduce fouling. There are moreover known films made of nylon with nylon fibers on the surface that also prevent fouling. Both types of film reduce fouling but have poor antifriction properties. Both types of film are applied by adhesive bonding and lack any damping effect. The films also lack abrasion resistance with respect to hard or abrasive substances such as sand. Both types of film also have relatively high density.

The market offers paints, coating materials and liquid coating compositions that are also intended to reduce fouling under water by various mechanisms. By reducing or preventing fouling, these films and paints reduce fuel consumption or increase velocity for identical power input.

It is an object of the invention to provide, for ships and boats, a multifunctional “dolphin skin” that has better antifriction characteristics in water than previous coating solutions. This is intended, in comparison with known coatings, to achieve higher velocity for identical power input or to reduce fuel consumption. The coating is also intended to reduce fouling and corrosion and to improve acoustics and laminar flow. The object is therefore, in comparison with systems that have been commercially available hitherto, to increase the ultimate velocity of sports boats, ships and in particular container ships for identical power input, or to reduce fuel consumption for identical velocity. Another object is for the external coating to optimize absorption of impacts.

These objects are achieved by the invention in that the coating in the submarine sector, characterized in that the coating in particular in the form of film has an underlayer made of an adhesive or of an ethylene-propylene-diene rubber (EPDM), in contact with the outer surface of the hull and, arranged thereon, an upper layer made of an ultrahigh-molecular-weight polyethylene (UHMWPE).

The structure of the coating consists of a UHMWPE film as upper layer. UHMWPE has excellent antifriction properties and equally has excellent capability for fabrication to provide structures similar to those of the skin of a shark. The film can be impregnated with wax or with other additives in order to increase antifriction properties. The film moreover has excellent ability to resist abrasion, to inhibit fouling, to facilitate cleaning, and to provide protection from impact.

Lamination of the UHMWPE film with EPDM as underlayer produces a novel combination similar to dolphin skin that absorbs the vibrations resulting from flow and thus actively increases laminar flow or flow velocity. This combination of materials leads moreover to markedly improved strength and to sound-deadening.

The buffer effect of the EPDM and the notched impact resistance of the UHMWPE provide novel damage-protection to the steel hull and therefore provide excellent corrosion protection alongside the antifouling effect.

Specifically in the case of modern GRP/CRP hull structures, it is possible to introduce a directly bonded laminate during manufacture and thus produce an inseparable composite. Impact resistance is significantly increased in this combination.

The thickness ratio of upper layer to underlayer can be adjusted individually for the size of the ship and the velocity to be achieved. Advantageous embodiments of the invention are listed in the dependent claims.

Embodiments of the invention are described below.

The film for the coating of the external areas of a ship hull or boat hull has a two- or multilayer structure and has at least one underlayer made of an ethylene-propylene-diene rubber (EPDM), preferably in the form of calendered film. An upper layer in particular in the form of film, made of an ultrahigh-molecular-weight polyethylene (UHMWPE) has been applied to this underlayer. Underlayer and upper layer have preferably been bonded to one another by vulcanization, and the product can be described as “laminate”.

The laminate is adhesive-bonded to steel hulls, and the edge regions are welded side-to-side. In the case of hulls made of GRP/CRP, the laminate can be introduced into the mold or adhesive-bonded subsequently.

The preferred thickness of the UHMWPE film is from 0.5 mm to 3 mm, and the preferred thickness of the EPDM is from 0.5 mm to 30 mm, depending on the application. The coating can also alternatively take the form of a two- or multilayer panel.

The laminate can be constructed with various layers and, if necessary, can be reinforced with films, with steel textiles, with synthetic textiles or with other textiles. Additives can be added to the UHMWPE film in order to improve the corresponding properties, examples being PTFE (antifriction characteristics, antiadhesive characteristics), carbon black (for conductivity), UV stabilizers (improvement of UV-resistance) and biocides to counter growth of algae.

It is preferable that the underlayer consists to some extent or entirely of various elastomers such as silicone, butyl, chloroprene, nitrile (NBR or HNBR) or other fluoroelastomers. It is preferable that the underlayer is a single- or two-component adhesive, in particular an epoxy resin with a hardener. The underlayer can also be an acrylate adhesive, in particular an acrylate foam adhesive.

The molar mass of the upper layer made of UHMWPE is preferably from 3 million g/mol to 15 million g/mol, preferably from 5 million g/mol to 10 million g/mol. The upper layer moreover advantageously consists of cross linked PE or cross linked PE plastomer with from 30% to 90% gel content, preferably from 40% to 70%.

The underlayer moreover particularly advantageously compensates differences in coefficient of expansion between the hull and the upper layer.

1. An external ship-hull coating in the submarine sector, wherein the coating in particular in the form of film comprises:
an underlayer made of an adhesive or of an ethylene-propylene-diene rubber, in contact with the outer surface of the hull and, arranged thereon,
an upper layer made of an ultrahigh-molecular-weight polyethylene.

2. The coating according to claim 1, wherein the thickness of the upper layer is from 0.5 to 3 mm.

3. The coating according to claim 1, wherein the underlayer is a single- or two-component adhesive.

4. The coating according to claim 3, wherein the single- or two-component adhesive is an epoxy resin with a hardener.

5. The coating according to claim 1, wherein the underlayer is an acrylate adhesive.

6. The coating according to claim 1, wherein the thickness of the underlayer is from 0.5 to 30 mm.

7. The coating according to claim 1, further comprising:
at least one further reinforcement layer arranged between the underlayer and the upper layer and/or under the underlayer.

8. The coating according to claim 7, wherein the reinforcement layer is at least one textile made of steel, plastic and/or glass.

9. The coating according to claim 8, wherein the textile is in the underlayer.

10. The coating according to claim 7, wherein the reinforcement layer has embedded glass fibers and/or carbon fibers.

11. The coating according to claim 1, further comprising:
additives comprised of PTFE, carbon black, UV stabilizers and/or flame-retardant substances in the upper layer and/or underlayer.

12. The coating according claim 1, wherein the film is a laminate.

13. The coating according to claim 1, wherein the underlayer consists at least partially of elastomers such as silicone, butyl, chloroprene, nitrile or other fluoroelastomers.

14. The coating according to claim 1, wherein the molar mass of the upper layer made of ultrahigh-moleular-weight polyethylene is from 3 million g/mol to 15 million g/mol.

15. The coating according to claim 1, wherein the upper layer consists of cross linked polyethylene or cross linked polyethylene plastomer with from 30% to 90% gel content.
